(19) United States
(12) Patent Application Publication
(10) Pub. No.: US 2025/0348488 A1
(43) Pub. Date: Nov. 13, 2025

(54) QUERY MANAGEMENT TOOL AND METHODS

(71) Applicant: Morgan Stanley Services Group Inc., New York, NY (US)

(72) Inventors: Blake Browne, Fairfield, CT (US); Manoj Arora, East Brunswick, NJ (US); Aastha Singh, Hoboken, NJ (US); Jimish Mody, Lutz, FL (US); Neha Lalit, Cumming, GA (US); Srinivas Alladi, Princeton Junction, NJ (US)

(73) Assignee: Morgan Stanley Services Group Inc., New York, NY (US)

(21) Appl. No.: 18/657,973

(22) Filed: May 8, 2024

(51) Int. Cl. G06F 16/2453

(52) U.S. Cl. CPC G06F 16/24542

(57) ABSTRACT

A computer-implemented method of deploying data sourced from disparate data environments in a defined form using queries. The method comprises establishing a data pipeline to each of the disparate data environments, creating a query, at a user interface, that defines a request for data from the disparate data environments, onboarding the query to a query storage, transferring the query to the data pipeline, responding to the query by preparing data sourced from the disparate data environments, and delivering the response to the query to an end user application, in which the data is deployed according to a user-selected configuration.

### FIELD OF THE DISCLOSURE

The present disclosure relates to data processing, and more particularly, relates to a system and method for sourcing and deploying data from a variety of disparate data environments at scale and in near real-time.

### BACKGROUND OF THE DISCLOSURE

Many organizations deploy personnel to various locations, such as to customers and remote facilities. In this capacity, such personnel are referred to as “field” personnel (or equivalently to “users in the field”). Such field personnel often need ready access to organizational information services, such as, for example, analytic and database operations. When there are large numbers of field personnel, such services need to be deployed reliably at scale.

Field personnel interact with the organizational systems using various platforms and tools. In many instances, such platforms and tools are not well-designed for large scale field interactions. For instance, it has been found that certain services face challenges in responsively scale requests from the field for a variety of data points without undergoing the software development life cycle (SDLC). This is particularly the case where the data points are stored in disparate data environments. The need to enter software development causes long lead time for requests, technical development bottlenecks, cost constraints, and, more generally, leads to an unscalable solution.

It would therefore be useful to provide a service that overcomes the difficulties associated with the SDLC, and that dynamically deploys, configures and formats data points to field personnel according to their specific requests.

### SUMMARY OF THE DISCLOSURE

The present disclosure describes a computer-implemented method of deploying data sourced from disparate data environments in a defined form using queries. The method comprises establishing within the computer implementing the method a data pipeline to each of the disparate data environments, creating a query, at a user interface, that defines a request for data from the disparate data environments, onboarding the query to a query storage, transferring the query to the data pipeline, responding to the query by preparing data sourced from the disparate data environments, and delivering the response to the query to an end user application, in which the data is deployed according to a user-selected configuration.

In another aspect, the present disclosure describes [a computer-implemented system for deploying data sourced from disparate data environments in a defined form using queries that are executed using computing devices on a network. The system comprises: i) a Query Management Tool having a user interface, through which a query for data stored in disparate data environment is defined, the Query Management Tool further including a Query Management Integration Service configured to transmit metadata related to use cases of the query; ii) Query Storage configured to store query data coupled to the Query Management Tool via the network; iii) a Query Data Pipeline coupled via the network to the Query Management Tool and to the Query Storage, the Query Data Pipeline being configured collect data from the disparate data environments in response to commands received from the QMT based on data in query storage to execute the query and prepare data for use; and iv) a Query Management Integration Component coupled to the Query Management Integration Service, to the Query Data Pipeline, and to one or more downstream applications, the Query Management Integration Component being configured to receive metadata from the Query Management Information service and data prepared by the Query Data Pipeline and to generate a user experience according to a use case configuration for the one or more downstream applications.

These and other aspects, features, and advantages can be appreciated from the following description of certain embodiments and the accompanying drawing figures and claims.

### BRIEF DESCRIPTION OF THE DRAWINGS

FIG. 1 is a schematic diagram of an embodiment of a system for source and deploying from disparate data environments at scale and near real-time using queries.

FIG. 2 is an exemplary view of a user interface of a QMT landing page according to an embodiment of the present disclosure which appears in the QMT UI.

FIG. 3A shows an exemplary user interface screen that appears in the QMT-UI for adding a query based on an Excel data source.

FIG. 3B shows an exemplary user interface screen that appears in the QMT-UI for adding a query based on a Datalake Based Targeting (DLBT) data source.

FIG. 4A shows an exemplary user interface screen that appears in the QMT-UI for the pop-up use case according to an embodiment of the present disclosure.

FIG. 4B shows an exemplary user interface screen that appears in the QMT-UI for the filter use case according to the present disclosure.

FIG. 4C shows an exemplary user interface screen that appears in the QMT-UI for the custom columns use case according to the present disclosure.

FIGS. 5A and 5B show an exemplary user interface for the first engagement application in which the opportunity created using the QMT is displayed.

FIG. 6 is an example pop up in the user interface that appears if a client is selected and activated from the relevant client section of FIGS. 5A and 5B.

### DESCRIPTION OF CERTAIN EMBODIMENTS OF THE DISCLOSURE

It is initially noted that certain features described herein that are described as discrete entities such as a “Component”, “Service”, “Application”, “Tool” or “Module”, are software programs or a group of software programs and related data that performs and/or controls a group of related processes. These programs can include applications, interfaces, libraries, scripts, procedure calls, and generally any code and data that is tailored for the processes that the program or group of programs performs and controls. The programs can be executed using a single hardware processor, or multiple hardware processors acting in concert. The processors can be hosted locally, externally (e.g., on the cloud) or any combination of the two.

The present disclosure describes a Query Management Tool (QMT). The QMT is a query repository that is configured to source data points from a variety of disparate data environments (e.g., data storage platforms) via an initial data pipeline. The QMT provides a user interface through which users have the capability to create and modify queries. The queries are structured requests for information from the data environments. The user interface enables users to apply specific criteria (e.g., business-related criteria) and target outcomes for use cases. The QMT is then configured to deploy data received through the queries, specific to applicable use cases and platforms. The QMT thereby enables a ‘low-code’ or ‘no-code’ environment in which non-technical users can interact with the tool, with the ability to deploy technical-specific criteria to their respective platforms and contexts. Furthermore, the QMT provides users with the capability, scale, and flexibility to deploy data near real-time.

More specifically, once a successful connection to a data environment has been established via the data pipeline, the QMT enables end-users to upload their specific query to execute upon the respective environment to conduct the request. Queries can be used for multiple purposes including obtaining content, targeting and pulling dynamic data attributes (DDA). Through the QMT, the user can create “opportunities” which can incorporate data from multiple queries and can consolidate data from various disparate data environments. In this manner, opportunities generated using the QMT essentially create a new model of data to be deployed. The QMT also enables users to link queries to the opportunities to direct the deployment of the data points. Once opportunities and queries have been linked, the user can develop use cases for data deployment according to specific needs.

The QMT leverages data as a resource and thereby eliminates or reduces the Software Development Life Cycle (SDLC) required to create data points in each specific platform. A considerable amount of time and resources would otherwise be required to respond to such requests that require a SDLC. Additionally, the QMT is configured to integrate with engagement tools that various personnel can use to view and customize various kind of data.

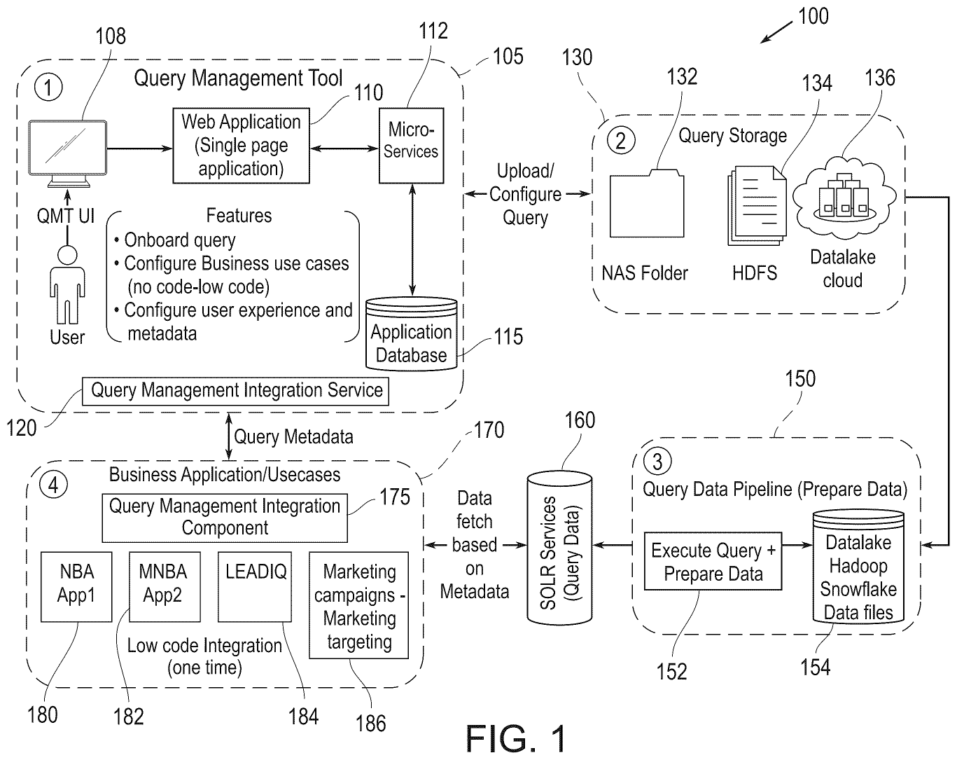

FIG. 1 shows a block diagram of a system 100 for sourcing, managing and deploying queries and corresponding data flow according to an embodiment of the present disclosure. A Query Management Tool 105 (“QMT”) is an application that can be executed on an operating system or virtual environment based ultimately on hardware-executable instructions. The QMT 105 is utilized to onboard queries, configure use cases and also to configure the user experience. More specifically, the QMT 105 provides a user interface 108 (“QMT UI”) that allows users to interact with other elements of the QMT. Through the QMT UI 108, the user can activate a web application 110. The web application 110 is communicatively coupled to a microservice module 112 which is configured to mediate between the QMT UI 108 and an application database 115 to which it is communicatively coupled over a computer network. The application database 115 is, in turn, coupled to a Query Data Pipeline 150 through which the application database has access to all relevant data from the disparate data environments. In operation, the microservices module 112 makes a call to the application database 115 to extract data related to a query. The application database is configured to return relevant data to the microservice module 112 and to provide supplemental information to the Query Data Pipeline 150. The QMT 105 also includes a query management integration service 120 which is an application program interface (API) that enables the components of the QMT to communicate (e.g., commands, data) with downstream applications 170.

The QMT 105 is communicatively coupled over a computer network to Query Storage 130. The QMT 105 is configured to upload queries to the Query Storage 130 and to edit and configure queries already stored in Query Storage 130. Generally, Query storage 130 contains data uploaded or referenced in QMT opportunities. Current query sources include excel and DLBT (Data Base Lake Targeting). DLBT queries are SQL queries that derive data dynamically from Datalake sources.

For example, when a user uploads an excel file related to a query, it is reserved in the Query Storage 130. Query Storage 130 contains a repository of all the data files used by the QMT application while the Query Data Pipeline 150 contains the specific data. In the depicted embodiment, Query Storage 130 includes a network attached storage (NAS) folder 132 that is used to store spreadsheet data such excel and CSV (Comma Separated Value) files. These files are distinguished by requiring no further data processing. In the depicted embodiment, the Query Storage 130 further includes a first distributed file system 134. In some embodiments, the first distributed file system is a Hadoop Distributed File System (HDTS). Hadoop is an open-source software framework that is used for storing and processing large amounts of data in a distributed computing environment. The HDTS system 134 is configured as an internal cloud in which data tables are stored as Hive Query Language (.hql) queries. It is based on the MapReduce programming model, which allows for the parallel processing of large datasets. Query Storage 130 also includes a Datalake cloud 136. In some embodiments, the Datalake cloud 136 can be implemented using Microsoft Azure. Data in the Datalake cloud 136 can be accessed through Structural Query Language (.sql files). When a DLBT query is uploaded in the QMT interface, it is loaded in HDFS system 134 or the Datalake cloud 136 to be used or referenced subsequently. The components of Query Storage 130 transfer queries into the Query Data Pipeline 150 for the data to be prepared and for downstream applications to consume the data.

The Query Data Pipeline 150 includes a data repository 154 that collects data prepared in response to commands from the QMT application database 115 based on data in Query Storage 130 including data from the NAS 132, HDFS 134 and DataLake Cloud 136. The Query Data Pipeline 150 is the product specific data pipeline used to read the specific queries from Query Storage 130. The Query Data Pipeline 150 comprises an execution module 152 that operates with the temporary data repository 154 to execute the query and prepare the data for the ultimate consumer (user). The Query Data Pipeline 150 sends the data output from the executed query to search platform module 160. In some embodiments, the search platform module can be implemented using Apache SOLR which is an open-source enterprise-search platform written in Java which runs as a standalone full-text search server. The search module platform 160 obtains data based on received metadata and sends the fetched data to a set of user engagement applications 170. Query data is cached in the search platform module 160 for optimized high volume reads during the user experience rendering. Data is pulled from the search platform module 160 via the microservices module 112 and aggregated to configure the data displays in application user interfaces. The search platform module 160 can output such data in a standard format, such as JSON. An example output of the search platform module is as follows, listing a number of features (fields) and specific data:

{“qtime”:46,“numFound”:12,“stats”:[ ],“flags”:null,“solrQTime”:6,“results”:[{“idn_msid_s”:“72GFC”,“id”:“
72GFC!FA-72GFC 147”,“contact_id_s”:“72GFC”,“idn_racf_s”:“P72GFC”,“full_name_s”:“XXXX,
XXXx”,“preferred_name_s”:“YYYY”,“email_s”:aaaa.bbbb@xyz.com,“total_assets_td”:103810163.142116
,“t12_revenue_td”:347325.73,“last_engagement_date_s”:“02/26/2024”,“branch_id_s”:“147”,“branch_n
ame_s”:“BBBBBB”,“branch_id_name_s”:“147-BBBBB”,“office_fa_ss”:[“147-
011”],“complex_s”:“CENTRAL-EASTERN NY”,“region_s”:“NORTHEAST”,“job_description_s”:“Financial
Advisor”,“emp_role_s”:“Financial Advisors”,“emailcount30days_s”:“6”,“campaign_status_s”:“Eligible”}]

Referring again to the QMT 105, once use cases are developed using the QMT, the use cases can be used in additional applications 170 that utilize query data. This is accomplished through an interface between the Query Management Integration Service 120 of the QMT 105 and a Query Management Integration Component 175 that is separate from the QMT. The Query Management Integration Service 120 is configured to expose and distribute use cases (described below). In the depicted embodiment, the management integration service includes three components: metadata, a user interface experience (UI), and behavior configurations. The behavior configurations concern how the integration service reacts to user input. The Query Management Integration Service 120 stores all information that is configured to be applied to different applications that use the query data.

The Query Management Integration Component 175 is configured to consume the service of the search platform module 160 so that configurations can be implemented to various applications with the aim of decreasing data delivery time. The Query Management Integration Component 175 pulls data from the search platform module 160 based on information from the microservices module 112 which is prepared by overnight batch process execution. The Query Management Integration Service 120 and the Query Management Integration Component 175 share query metadata, and in particular the query logic, that is generated using the QMT. The Query Management Integration Component 175 uses the metadata received from the Query Management Integration Service 120 of the QMT which includes use case configuration data to prepare a user experience including such item as grids, filters etc. based on the use case data.

Among the applications that utilize the query data are a first engagement application 180 that enables field personnel (e.g., financial advisors) to communicate with clients using various data points accessible by suitable queries. A second engagement application 182 is a scalable tool that enables managers and home office users to communicate with one another using various data points also accessible using suitable queries. A relationship management application 184 leverages enterprise client relationships and determines suitable channels for providing services based on suitable queries. The user engagement applications also include a marketing campaign application 186.

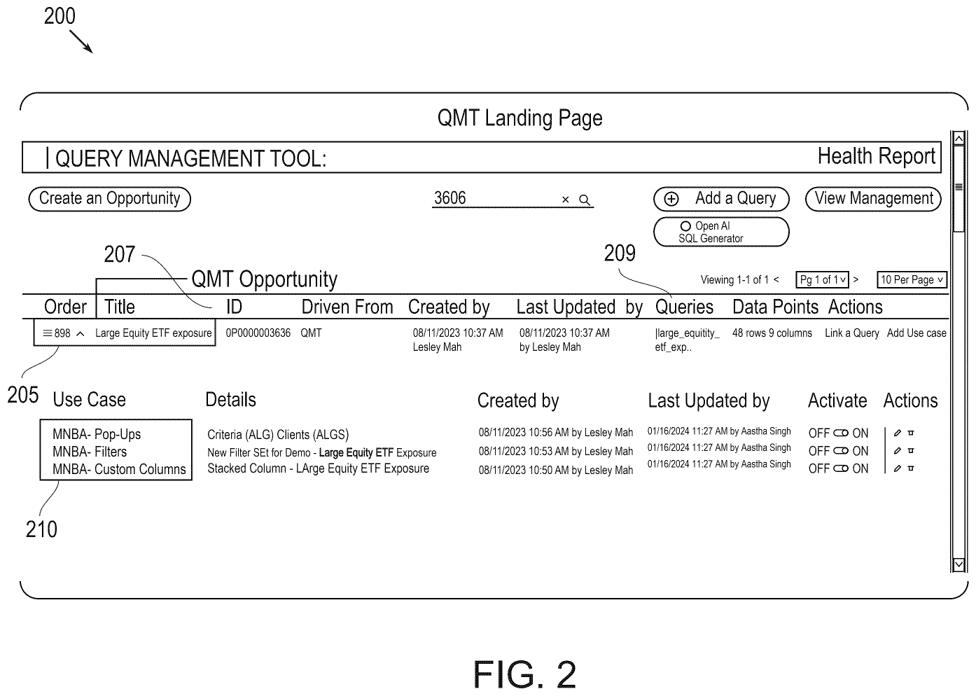

FIG. 2 is an exemplary view of a user interface of a QMT landing page according to an embodiment of the present disclosure which appears in the QMT UI 108. The landing page 200 allows users to create and view “opportunities”. Opportunities are defined herein as ways of consolidating and deploying data points from any onboarded data environment onboarded. Put another way, an opportunity is a way of deploying a new model of data. In the landing shown in FIG. 2, there is an opportunity 205 called “Large Equity ETF Exposure”. The opportunity is associated with an opportunity ID 207. Each opportunity 205 can be associated with any number of use cases. Use cases are ways of utilizing the data points of an opportunity using a query. Use cases therefore link opportunities and queries. In the example shown in FIG. 2, there are three uses cases for the opportunity “large equity ETF exposure” 205. The query 209 enables opportunities to target specific users based on available data. The use cases 210 include a pop-up 212 that is sorted by client, a filter 214 that segregates the opportunity, and custom columns 216 that define whether the opportunity is to be stacked or in a single column.

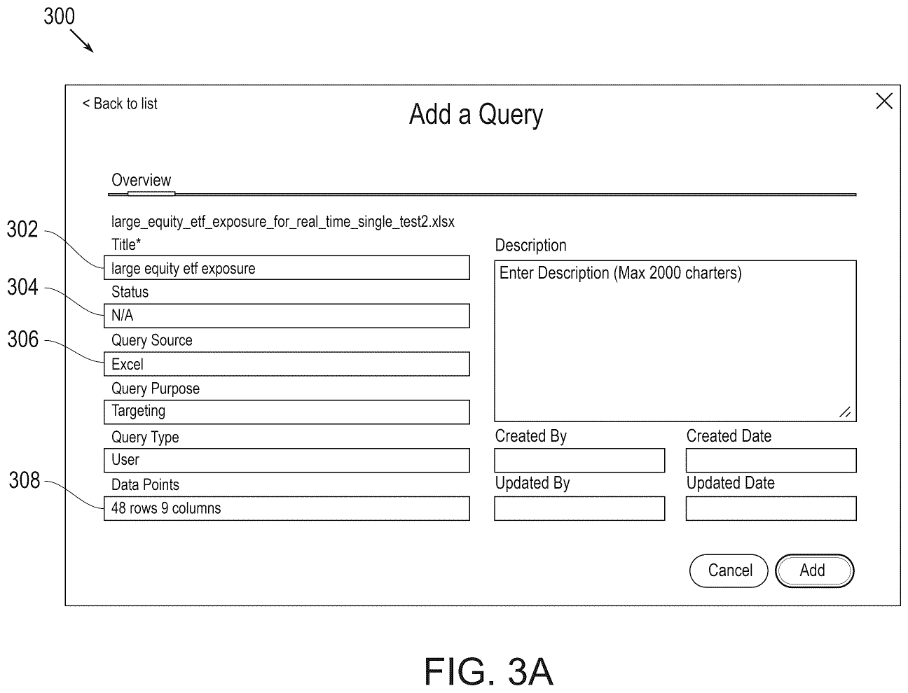

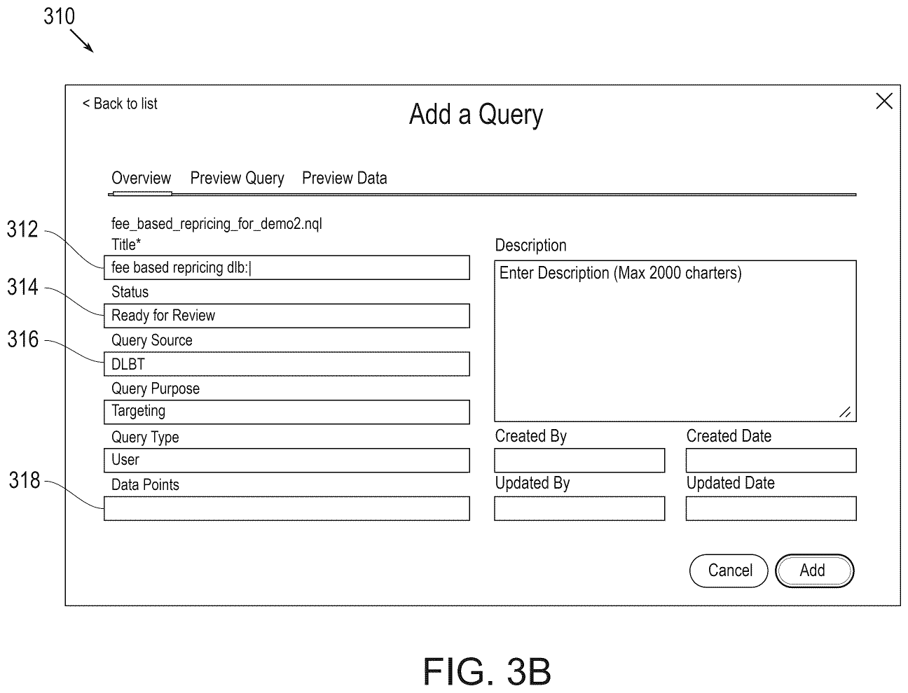

FIG. 3A shows an exemplary user interface screen that appears in the QMT-UI for adding a query based on an Excel data source. Fields entered into the interface 300 include, among others, a title 302, status 304, query source 306 (e.g., Excel file) and data points 308 (indicating the dimensions of the data). When excel files are used as the data source, the upload modal automatically displays the rows and columns present in the Excel file. FIG. 3B shows an analogous user interface screen that appears in the QMT-UI for adding a query based on a DLBT data source. Fields entered into the interface 310 include, among others, a title 312, status 314, query source 316 (DLBT file) and data points 318. The data points field 318 is empty in this case indicating that, unlike an Excel file, the structure of the data points may not be known. For DLBT files, the upload modal does not initially display data points. Once the query is added, the microservices module 112 receives the query and determines whether the query is valid or not based on improper syntax or lack of access to underlying tables of data. If the query is determined to be valid, the modal displays the relevant data points.

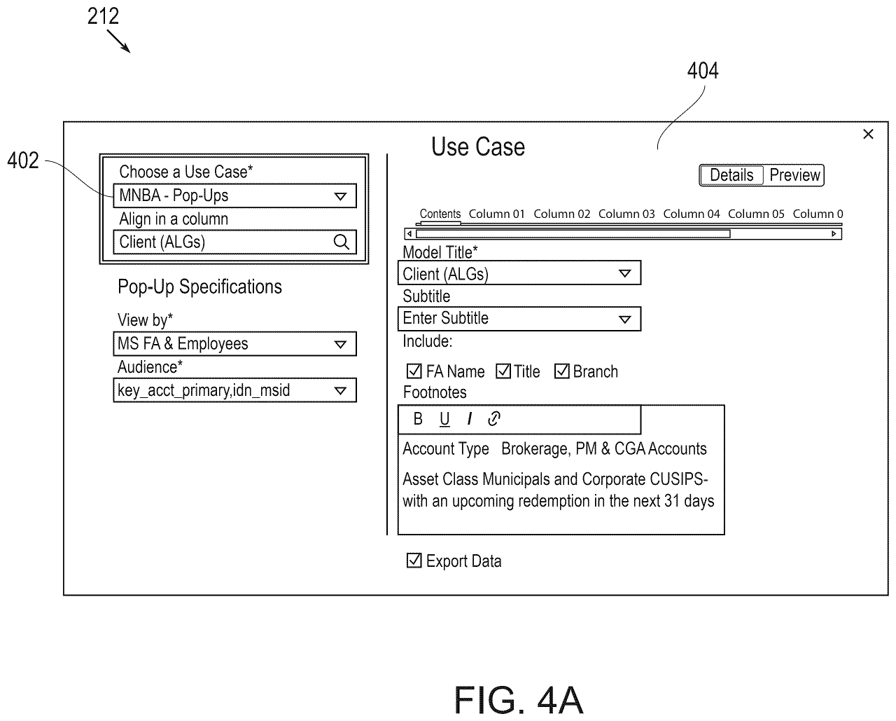

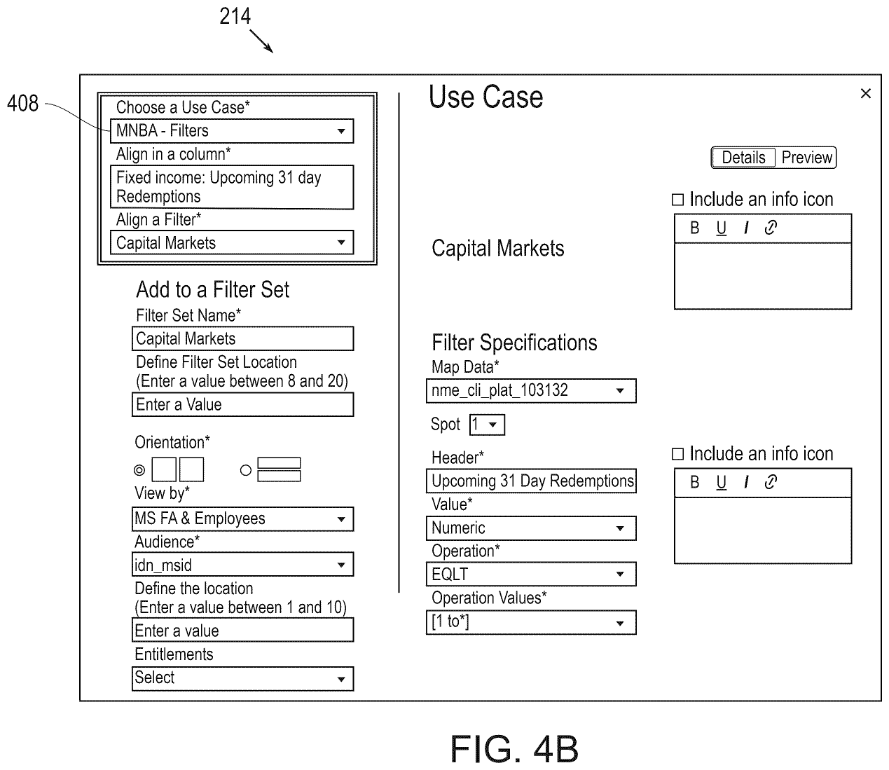

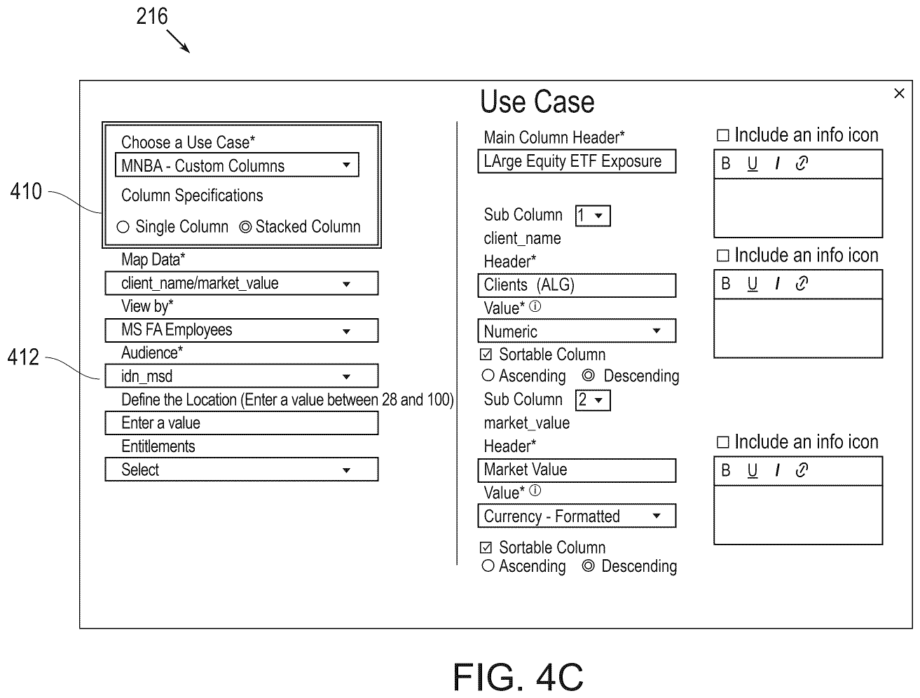

FIG. 4A shows an exemplary user interface screen that appears in the QMT-UI for the pop-up use case 212. The use case may be associated with one of the applications 170 shown in FIG. 1. As shown, a selection box 402 allows the user to select the type of use case, in this case a pop up, which is a pop-up window that will appear in the first engagement application 180. Once a pop-up is selected, users have the ability to add multiple columns and add footnotes to provide details about the pop-up through a details section 404 of the UI.

FIG. 4B shows an exemplary user interface screen that appears in the QMT-UI for the filter use case 214. As shown, a selection box 406 allows the user to select the type of use case, in this case a filter, which will be displayed the first engagement application 180. Filter use cases have an “add to filter set” section 408 and a “filters specification section” that enables users to choose filter operations and operation values. FIG. 4C shows an exemplary user interface screen that appears in the QMT-UI for the custom columns use case 216. The custom column use case UI 216 provides user with the ability to set column specification 410, as well as tools to map data as well as tools to select an audience 412.

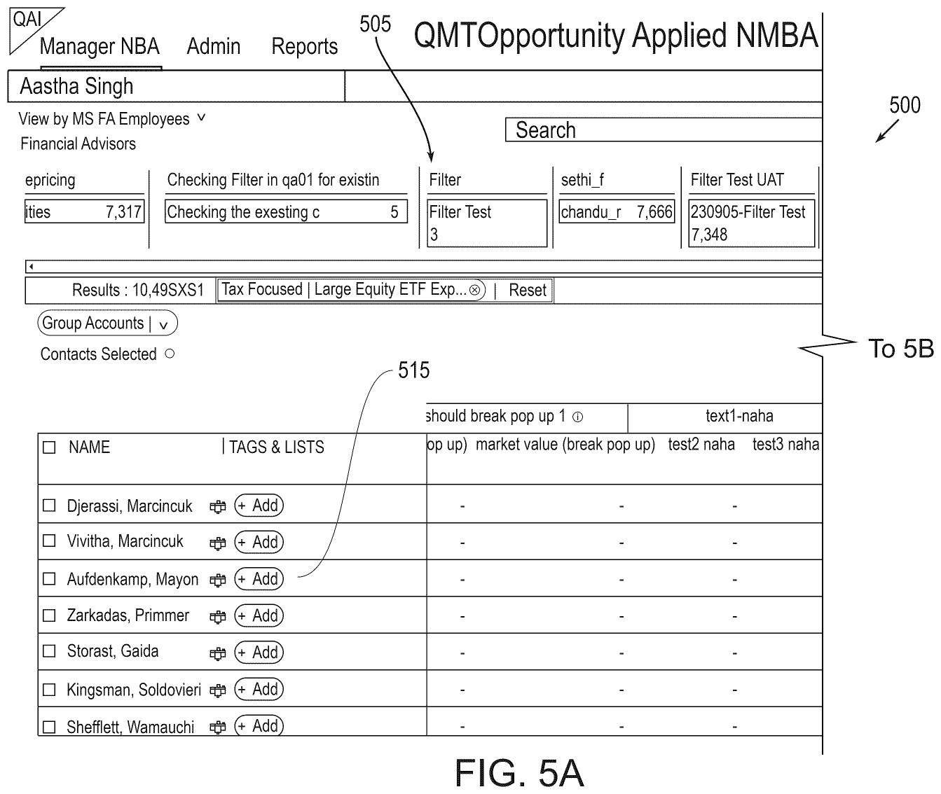

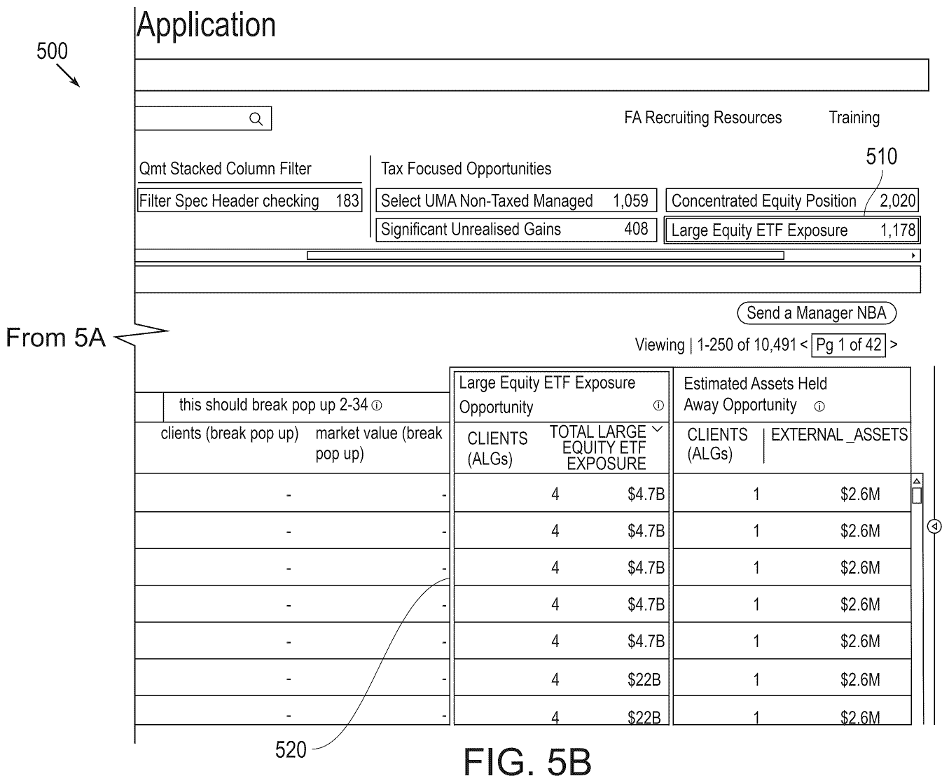

FIGS. 5A and 5B show an exemplary user interface 500 for the first engagement application 180 in which the opportunity created using the QMT 105 is displayed. The top of the UI shows filter attributes 505 that have been selected for the use case to funnel data for the opportunity. The selected opportunity 510 is shown at the top right of the UI. The UI 500 also displays data including a listing of targets 515 for the opportunity as well as an opportunity column 520 which includes data that links the opportunity to the targets. In this case, the opportunity column 520 is sacked, meaning that there are two columns under a single opportunity header.

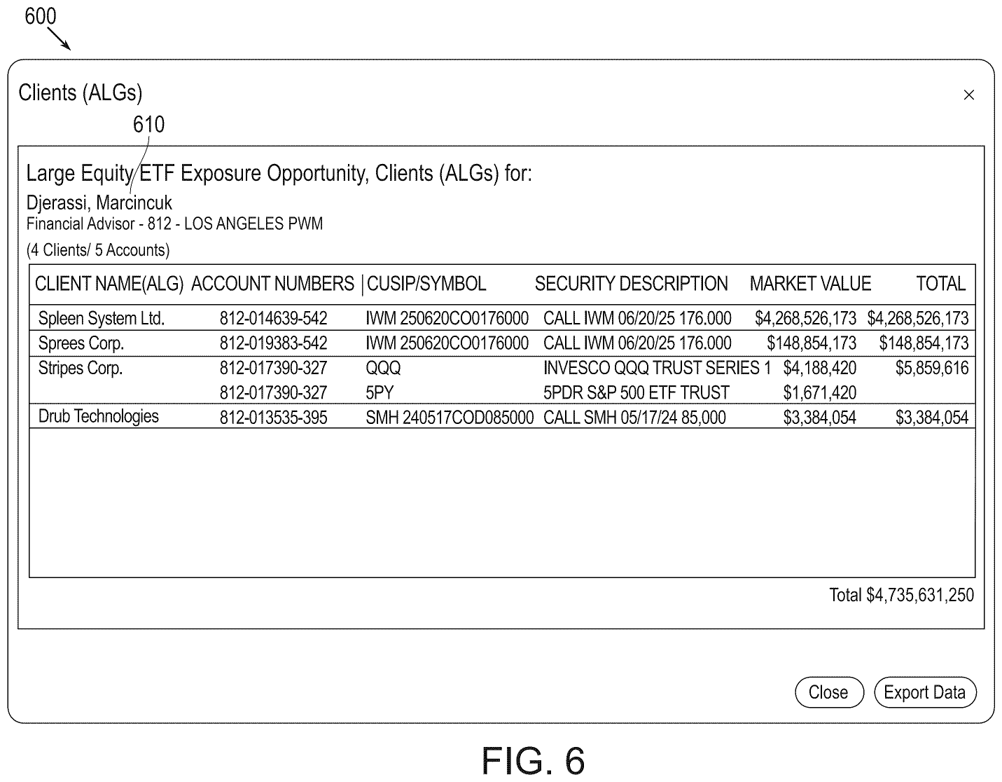

FIG. 6 is an example pop up in the user interface 600 that appears if a client is selected and activated from section 515 of FIGS. 5A and 5B. The pop up shown in FIG. 6 includes details of the selected client 610 such as various portfolio holdings of the client related to the opportunity. It is noted that numerous other pop-up screens and other features can be activated from the user interface 600 to provide additional details.

Embodiments of the systems and methods described herein and all of the functional operations described in this specification can be implemented in digital electronic circuitry, or in computer software, firmware, or hardware, including the structures disclosed in this specification and their structural equivalents, or in combinations of one or more of them. Embodiments can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter suitable for causing a machine-readable propagated signal, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computing device are a processor for performing instructions and one or more memory devices for storing instructions and data. The computing device can include, or be operatively coupled to receive data from or transfer data to, or both, one or more mass storage devices for storing data, e.g., magnetic, magneto optical disks, or optical disks. Moreover, the computing device can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, particularly with the user interfaces described herein, components described herein can be implemented on a computing device having a display device, e.g., a CRT (cathode ray tube) or LCD (liquid crystal display) monitor, for displaying information to the user and a keyboard and a pointing device, e.g., a mouse or a trackball, by which the user can provide input to the computing device. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the systems and methods described herein can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN).

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the disclosure has been described with reference to exemplary embodiments, it will be understood by those skilled in the art that various changes may be made and equivalents may be substituted for elements thereof without departing from the scope of the disclosed invention. In addition, many modifications will be appreciated by those skilled in the art to adapt a particular instrument, situation or material to the teachings of the disclosure without departing from the essential scope thereof. Therefore, it is intended that the invention not be limited to the particular embodiment disclosed as the best mode contemplated for carrying out this invention, but that the invention includes all embodiments falling within the scope of the appended claims.

1. A computer-implemented method of deploying data sourced from disparate data environments in a defined form using queries, the method comprising:
establishing a data pipeline to each of the disparate data environments;
creating a query, at a user interface, that defines a request for data from the disparate data environments;
configuring and storing a user experience and metadata related to use cases of the query;
onboarding the query to a query storage;
transferring the query to the data pipeline;
responding to the query by preparing data sourced from the disparate data environments based on the configured user experience and metadata; and
delivering the response to the query to an end user application, in which the data is deployed according to a user-selected configuration, wherein the user-selected configuration includes an output format, structure and field mappings.

2. The computer-implemented method of claim 1, further comprising:
creating an opportunity that incorporates data points from the disparate data environments; and
linking a query to the opportunity.

3. The computer-implemented method of claim 2, further comprising:
creating a use case for the opportunity for a scenario specific to a business application accessible by end users.

4. A computer-implemented system for deploying data sourced from disparate data environments in a defined form using queries that are executed using computing devices on a network, the system comprising:
a Query Management Tool having a user interface, through which a query for data stored in disparate data environment is defined and a user experience and metadata are configured, the Query Management Tool further including a Query Management Integration Service configured to transmit metadata related to use cases of the query;
Query Storage configured to store query data coupled to the Query Management Tool via the network;
a Query Data Pipeline coupled via the network to the Query Management Tool and to the Query Storage, the Query Data Pipeline being configured collect data from the disparate data environments in response to commands received from the QMT based on data in query storage to execute the query and prepare data for use; and
a Query Management Integration Component coupled to the Query Management Integration Service, to the Query Data Pipeline, and to one or more downstream applications, the Query Management Integration Component being configured to receive the metadata from the Query Management Information service and data prepared by the Query Data Pipeline and to generate the user experience according to the use case for the one or more downstream applications.

5. The computer-implemented system of claim 4, further comprising:
a search platform module coupled to the Query Data Pipeline and to the one or more downstream applications, the search platform module configured to obtain data specific to the query based on metadata received from the Query Data Pipelines, and to deliver the obtained data to the one or more downstream applications.

6. The computer-implemented system of claim 4, wherein the user interface of the Query Management Tool enables users to create an opportunity that incorporates data points from the disparate data environments, and to link the query to the opportunity.

7. The computer-implemented system of claim 6, wherein the user interface of the Query Management Tool further enables users to create a use case for the opportunity for a scenario specific to a downstream application.

8. The computer-implemented method of claim 1, wherein the end user application is one of a reporting application that enables communications using data points accessible using queries, and an enterprise application that manages client relationships and determines channels for providing services based on queries.
